(19) United States
(12) Patent Application Publication
(10) Pub. No.: US 2006/0151243 A1
(43) Pub. Date: Jul. 13, 2006

(54) Parapet mounted net system

(76) Inventor: John Rexroad, Killingworth, CT (US)

Correspondence Address: ELLIS & VENABLE, PC, 101 NORTH FIRST AVE., SUITE 1875, PHOENIX, AZ, 85003, US

(21) Appl. No.: 11/036,624

(22) Filed: Jan. 13, 2005

(51) Int. Cl. A62B 1/22

(52) U.S. Cl. 182/138

(57) ABSTRACT

Described is a net system that protects crew members working on high-rise buildings. The net system easily and quickly attaches to the outside of a building perimeter. The net system includes a parapet clamp, a vertical support arm, a mounting bracket, a cantilever arm, and a debris net. The parapet clamp is adjustable and also supports the debris net and vertical support arm. The vertical support arm extends down from the parapet clamp and attaches to the mounting bracket at its lower end. The lower end of the cantilever arm also attaches to the mounting bracket via a pivot pin which allows the cantilever arm to rotate. The debris net is suspended between the upper end of the cantilever arm and the parapet clamp. Among other things, the net system allows crew members to work on high-rise buildings without the risk of being injured by a fall or dropped objects.

### FIELD OF THE INVENTION

The present invention relates generally to an apparatus used for maintaining a safe work environment, more particularly, to an apparatus that comprises a net system that maintains a safe work area for crews working on high-rise buildings both on the ground and in the air. Specifically, the present invention utilizes an adjustable parapet clamp that attaches to a variety of sizes of parapet walls and window openings on a building and rigidly secures a net system to a building under construction or in need of repairs.

### BACKGROUND OF THE INVENTION

A crew maintaining or constructing a high-rise building must deal with many hazards in the work environment. Members of the crew on the ground and in the air must be constantly aware of their surroundings. Crew members on the ground must watch for dropped objects falling from above, and crew members working above ground must be conscious of where they are stepping to avoid a fall.

One way to protect the crew, public, and property below is to install a net system that surrounds the perimeter of a building. However, the installation process can be difficult because most high-rise buildings have parapet type walls around the perimeter of the building that vary in size and width. Therefore, there is not one standard size parapet clamp that will attach a perimeter safety net to every building. This can become problematic and time consuming for a crew trying to install a net system.

The present invention provides crew members with an easy and secure way to fasten a net system to a parapet wall or window opening around the perimeter of a building. The present invention comprises a parapet clamp that includes a pair of parapet bracket extension plates allowing the parapet clamp to adjust to fit varying sizes of parapet walls. The upper end of a vertical support arm is coupled to the parapet clamp and the lower end attaches to a mounting bracket. The mounting bracket also attaches to the lower end of a cantilever arm. The debris net is attached to the upper end of the cantilever arm and to the parapet clamp. The cantilever arm is attached to the mounting bracket with a pivot pin that allows the cantilever arm to rotate around the axis of the pivot pin. Once the parapet clamp is securely fastened to the parapet wall or window opening, the cantilever arm is released and the safety debris net is unfolded to an open position. A retention rope attached to the cantilever arm and the parapet clamp provides the crew members with an easy means to pull the cantilever arm into a position that is parallel to the vertical arm.

Currently, there are devices that use perimeter nets attached to buildings to protect people working on maintenance or construction crews. However, each of these devices suffers from several disadvantages. First, the devices are difficult to install on parapet walls or window openings. Because the parapet walls and window openings vary in size from building to building, each clamp must be changed on the net system each time it is installed on a different building. This can become time consuming and may result in an accident caused by human mistakes. Second, the prior art devices are complicated and require a time consuming and inconvenient process.

Presently, there is no net system that is easy to install on a parapet wall or window opening. For the foregoing reasons, a device that would allow maintenance or construction crews to easily install a net system around a building using a parapet wall or window opening is desired.

### SUMMARY OF THE INVENTION

It is an object of the present invention to provide a net system that is easy to install on a parapet wall or window opening.

It is a further object of the present invention to provide a net system that includes an adjustable clamp to fit a parapet wall, balcony, or windowsill.

It is a further object of the present invention to provide a net system that can be folded up against the building for cleaning or in inclement weather conditions.

It is a further object of the present invention to provide a net system that quickly and easily secures to the building.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a side view of the net system attached to a roof parapet.

FIG. 2 shows a front view of the net system installed around the outside of a building.

FIG. 2A shows a side view of the net system attached to a balcony parapet.

FIG. 2B shows a view of the net system attached to a window opening.

FIG. 3 shows a side view of the mounting bracket.

FIG. 4 shows a side view of the mounting bracket with a lateral cable attachment point.

FIG. 5 shows a side view looking down of the mounting bracket.

FIG. 6 shows a side view looking up of the parapet clamp.

FIG. 7 shows a perspective view of the parapet clamp and vertical support arm.

FIG. 8 shows a side view of the parapet clamp and vertical support arm.

FIG. 9 shows a back view of the vertical support arm attached to the parapet clamp.

FIG. 10 shows a perspective view of the upper end of the cantilever arm and retention rope.

### DESCRIPTION OF PREFERRED EMBODIMENTS

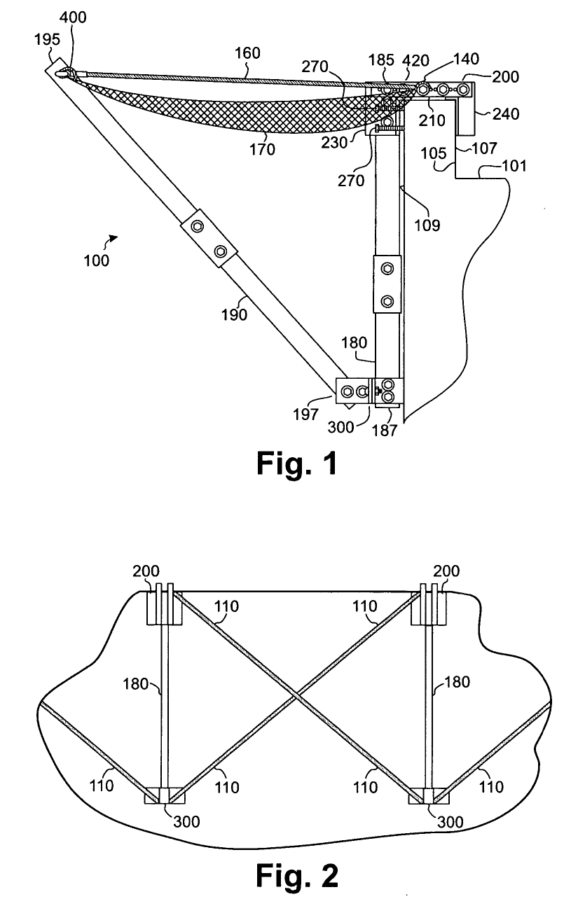

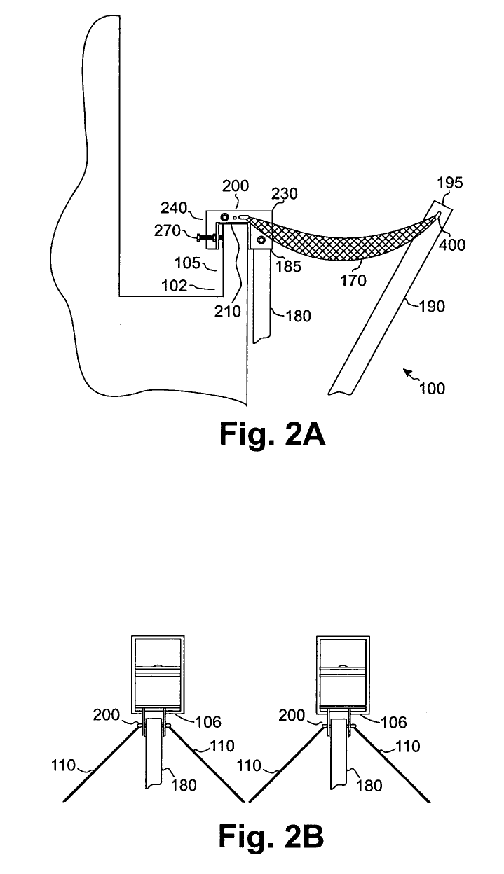

As shown in FIG. 1, the preferred embodiment of the net system 100 generally includes a parapet clamp 200, a vertical support arm 180, a mounting bracket 300, a cantilever arm 190, a retention rope 160, and a debris net 170. These components work together to secure a net system 100 to a parapet wall 105 of a building, as shown in FIGS. 1 through 2B. Specifically, the net system 100 can connect anywhere on a building where a parapet wall 105 is present. FIG. 2A shows an embodiment of the invention where the net system 100 is connected to a balcony parapet 102; FIG. 1 shows the net system 100 connected to a roof parapet 107; and FIG. 2B shows the net system 100 connected to a window parapet 106.

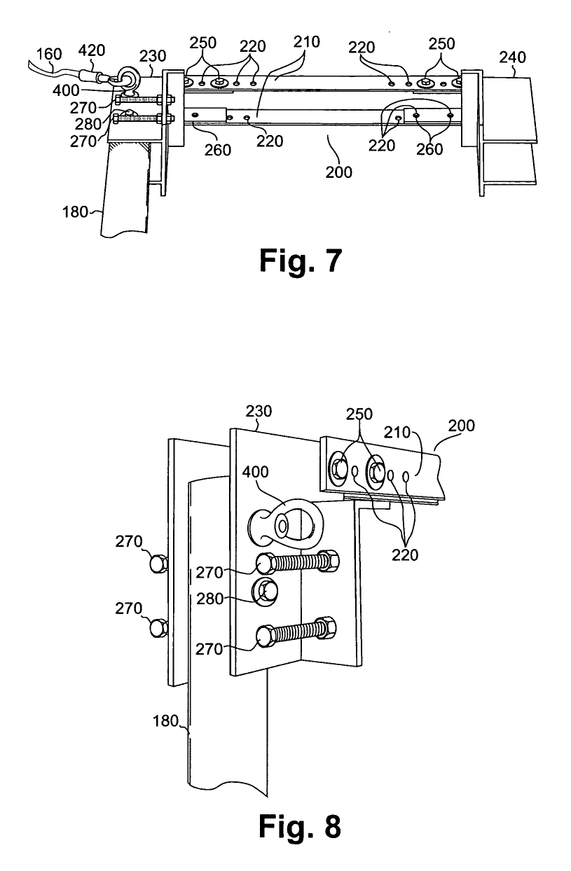

The parapet clamp 200 includes an outer parapet bracket 230, an inner parapet bracket 240, and a pair of parapet bracket extension plates 210, as in FIGS. 6 and 7. The parapet bracket extension plates 210 comprise threaded bolt holes 220 evenly spaced apart along the extension plates 210 that correspond to the bolt holes 260 in the outer and inner parapet brackets, 230 and 240 respectively. The parapet bracket extension plates 210 are placed on the outsides of the outer and inner parapet brackets, 230 and 240 respectively, and extension plate attachment bolts 250 secure the extension plates 210 to the parapet brackets 230 and 240.

The outer parapet bracket 230 also includes two pair of clamp bolts 270 that secure the parapet clamp 200 to the parapet wall 105 by tightening them against the parapet wall 105. The tightened clamp bolts 270 hold the parapet clamp 200 in place on the parapet wall 105 without bolting or penetrating the building structure. When the net system 100 is removed from the building, the clamp bolts 270 are loosened and the parapet clamp 200 is easily removed without permanently altering (i.e. penetrating) the building structure.

The extension plates 210 allow the parapet clamp 200 to easily adjust to fit varying sizes of parapet walls 105. The extension plates 210 are removed and adjusted on the outer and inner parapet brackets 230 and 240 so that the outer and inner parapet brackets 230 and 240 can be positioned closer or further apart depending on the width of the parapet wall 105. Therefore, rather than removing the entire parapet clamp 200 from the debris net 170, the vertical support arm 180, and the retention rope 160 every time the net system 100 is moved between buildings with different sizes of parapet walls 105, only the extension plates 210 are removed and adjusted.

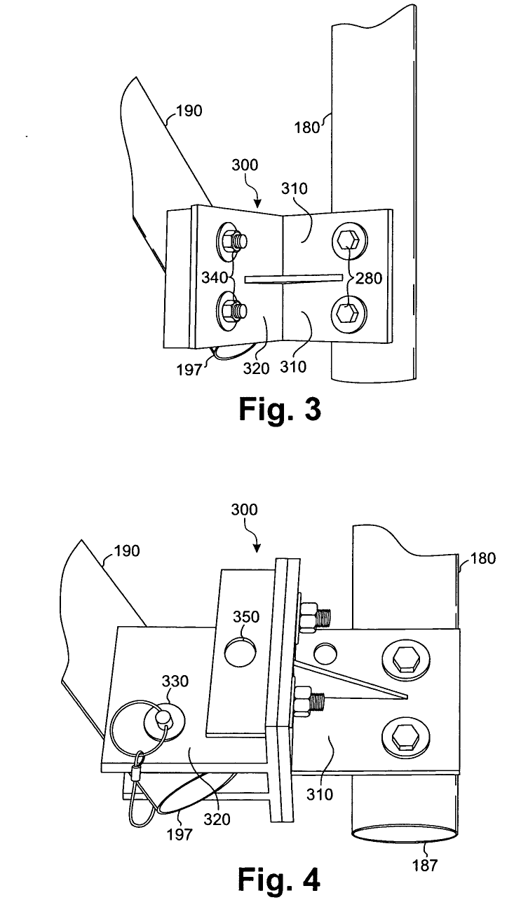

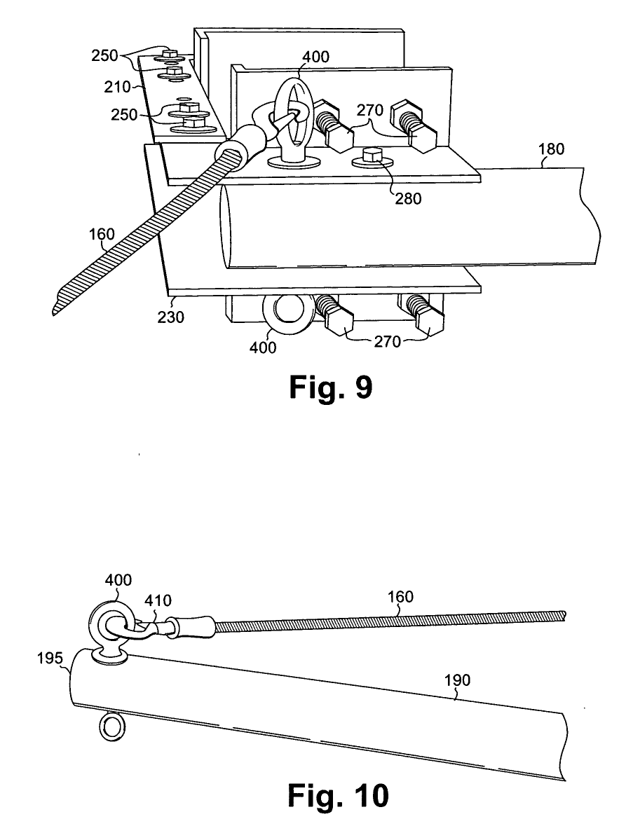

As shown in FIG. 1, the vertical support arm 180 extends downward from the outer parapet bracket 230 to the mounting bracket 300. The upper end 185 of the vertical support arm 180 is attached to the outer parapet bracket 230 with two pair of vertical support arm attachment bolts 280 as seen in FIGS. 8 and 9. The lower end 187 of the vertical support arm 180 is attached to the mounting bracket 300 with a pair of vertical support arm attachment bolts 280 as in FIG. 3.

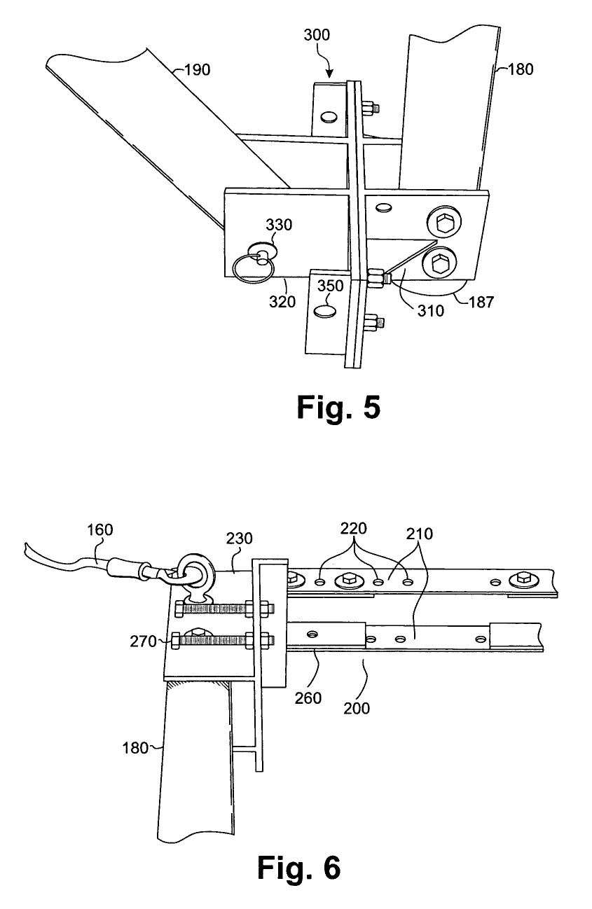

The mounting bracket 300, as seen in FIGS. 3, 4, and 5, preferably consists of two pieces, a vertical support mounting bracket 310 and a pivot mounting bracket 320, that are welded or bolted together. The vertical support mounting bracket 310 attaches to the lower end 187 of the vertical support arm 180, and the pivot mounting bracket 320 attaches to the lower end 197 of the cantilever arm 190. Preferably, as shown in FIGS. 4 and 5, the pivot mounting bracket 320 attaches to the cantilever arm 190 with a pivot pin 330 so that the cantilever arm 190 can rotate between an open position and a retracted position parallel with the vertical support arm 180. However, in an alternate embodiment shown in FIG. 3, the cantilever arm 190 attaches to the pivot mounting bracket 320 with a pair of cantilever arm support bolts 340 and is stationary.

When the cantilever arm 190 rotates on the pivot pin 330 and is in the open position, the debris net 170 is also open and in position to catch a person or an object falling from above. However, when the cantilever arm 190 is in a position parallel with the vertical support arm 180, the debris net 170 is folded. The retention rope 160 is used to rotate the cantilever arm 190 about the pivot pin 330. The second end 410 of the retention rope 160 is attached to the upper end 195 of the cantilever arm 190 with a retention rope attachment bolt 400 that is preferably an eyebolt 430. Similarly, the first end 420 of the retention rope 160 attaches to the outer parapet bracket 230 with a retention rope attachment bolt 400 that is preferably an eyebolt 430.

The debris net 170 is attached to the outer parapet bracket 230 and the upper end 195 of the cantilever arm 190 via an interior cable 140 and an outer cable 150. The interior cable 140 is attached to the outer parapet bracket 230, and the outer cable 150 is attached to the upper end 195 of the cantilever arm 190.

In another embodiment, the mounting bracket 300 can also include a lateral tie cable attachment point 350. The lateral tie cables 110, shown in FIG. 2, connect multiple net systems 100 together around a building to provide a net system that encompasses the entire perimeter of the building. The lateral tie cables 110 provide extra support to the net system.

The preferred embodiment of the invention is described above, in the Drawings, and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A parapet mounted net system comprising:
A. a clamp, said clamp further comprising
1. an inner bracket; and
2. an outer bracket;
B. a retention rope, said retention rope further comprising
1. a first end; and
2. a second end;
C. a net, said net further comprising
1. a first point; and
2. a second point;
D. a support arm, said support arm further comprising
1. a top; and
2. a bottom;
E. a cantilever arm, said cantilever arm further comprising
1. an upper end; and
2. a lower end;
F. a mounting bracket, said mounting bracket further comprising
1. a first side; and
2. a second side;
G. said clamp is coupled to a wall wherein said outer bracket is attached to an outside of said wall and said inner bracket is attached to an inside of said wall;
H. said top of said support arm is coupled to said outer bracket;
I. said bottom of said support arm is coupled to said second side of said mounting bracket;
J. said first end of said retention rope is coupled to said outer bracket of said clamp;
K. said second end of said retention rope is coupled to said upper end of said cantilever arm;
L. said lower end of said cantilever arm is coupled to said first side of said mounting bracket;
M. said first point of said net is coupled to said clamp; and
N. said second point of said net is coupled to said upper end of said cantilever arm.

2. The device of claim 1 wherein:
A. said parapet mounted net system further comprises at least one tie cable such that said tie cable is attached to said first side of said mounting bracket and to said outer bracket of said clamp such that said at least one tie cables connect a plurality of parapet mounted net systems.

3. The device of claim 1 wherein:
A. said clamp further comprises a bracket extension plate, such that said bracket extension plate is adjustably coupled to said outer bracket and said inner bracket.

4. The device of claim 1 wherein:
A. said outer bracket further comprises a securing clamp such that said first end of said retention rope is attached to said securing clamp.

5. The device of claim 1 wherein:
A. said outer bracket further comprises at least one clamp bolt such that said clamp bolt secures said clamp to said wall.

6. The device of claim 1 wherein:
A. said outer bracket further comprises at least one bolt hole such that said support arm is secured to said outer bracket with at least one bolt inserted into said bolt hole.

7. The device of claim 1 wherein said mounting bracket further comprises:
A. a pivot mounting bracket; and
B. a support mounting bracket;
C. wherein said pivot mounting bracket and support mounting bracket are permanently coupled such that said pivot mounting bracket and said support mounting bracket comprise said mounting bracket.

8. The device of claim 7 wherein:
A. said pivot mounting bracket further comprises a pivot pin such that said lower end of said cantilever arm is rotatably coupled to said pivot mounting bracket.

9. The device of claim 7 wherein:
A. said bottom of said support arm is coupled to said support mounting bracket.

10. The device of claim 1 wherein:
A. said upper end of said cantilever arm further comprises a securing clamp such that said second end of said retention rope is attached to said securing clamp.

11. A method of mounting a net system to a wall comprising the steps of:
A. coupling a clamp to a wall wherein said clamp consists of an outer bracket and an inner bracket;
B. attaching said outer bracket to an outside of said wall;
C. attaching said inner bracket to an inside of said wall;
D. coupling a top of a support arm to said outer bracket;
E. coupling a bottom of said support arm to a second side of a mounting bracket;
F. coupling a first end of a retention rope to said outer bracket of said clamp;
G. coupling a second end of said retention rope to said upper end of said cantilever arm;
H. coupling a lower end of said cantilever arm to a first side of said mounting bracket;
I. coupling a first point of a net to said outer bracket; and
J. coupling a second point of said net to said upper end of said cantilever arm.

12. The method of claim 11 further comprising the step of:
A. attaching at least one tie cable to said first side of said mounting bracket and to said outer bracket such that said tie cable connects a plurality of parapet mounted net systems.

13. The method of claim 11 further comprising the step of:
A. securing a bracket extension plate to said outer bracket and said inner bracket such that said bracket extension plate adjustably connects said outer bracket and said inner bracket.

14. The method of claim 11 further comprising the step of:
A. attaching said first end of said retention rope to a securing clamp on said outer bracket.

15. The method of claim 11 further comprising the step of:
A. attaching said second end of said retention rope to said upper end of said cantilever arm.

16. The method of claim 11 further comprising the step of:
A. securing said clamp to said wall with a clamp bolt attached to said outer bracket.

17. The method of claim 11 further comprising the step of:
A. securing said top of said support arm to said outer bracket with at least one bolt.

18. The method of claim 11 further comprising the step of:
A. securing said cantilever arm and said support arm to said mounting bracket, wherein said mounting bracket consists of a pivot mounting bracket and a support mounting bracket.

19. The method of claim 18 further comprising the step of:
A. securing said cantilever arm to said pivot mounting bracket with a pivot pin such that said cantilever arm rotates around said pivot pin.

20. The method of claim 18 further comprising the step of:
A. coupling said support arm to said mounting bracket such that said support arm is stationary.
